(19) United States
(12) Patent Application Publication
(10) Pub. No.: US 2024/0159096 A1
(43) Pub. Date: May 16, 2024

(54) AUTOMATIC DOOR CONTROL SYSTEM

(71) Applicant: GREENSHPON ENGINEERING WORKS LTD., Misgav (IL)

(72) Inventor: Shimon SEADIA, Zefat (IL)

(21) Appl. No.: 18/417,103

(22) Filed: Jan. 19, 2024

Related U.S. Application Data
(63) Continuation-in-part of application No. 16/965,302, filed on Jul. 28, 2020.
Application No. 16/965,302 is a continuation of application No. 15/881,970, filed on Jan. 29, 2018, now abandoned.
(60) Provisional application No. 63/440,111, filed on Jan. 20, 2023.

(51) Int. Cl. E05F 15/70; E05F 15/71; E06B 9/70; E06B 9/90; H02P 3/06

(52) U.S. Cl. CPC E05F 15/70; E05F 15/71; E06B 9/70; E06B 9/90; H02P 3/06; E05Y 2900/132; E05Y 2900/146; E06B 2009/6809

(57) ABSTRACT

An automatic door control system includes a door element that rotates in response to a change in position of a door, a first door position sensor configured to output a position signal based on rotation of the door element, a controller and a control device. The controller incudes memory containing a target position corresponding to an intermediate position of the door between maximally open and maximally closed positions of the door, and a processor configured to monitor a current position of the door based on the position signal and stop rotation of the door element when the current position matches the target position. The control device is configured to set the target position in the memory through a wireless communication link with the controller.

### CROSS-REFERENCE TO RELATED APPLICATION

The present application is a continuation-in-part of U.S. patent application Ser. No. 16/965,302, filed Jul. 28, 2020, which is National Stage Entry of International Patent Application No. PCT/IL2019/050112, filed Jan. 29, 2019, which is a continuation of U.S. patent application Ser. No. 15/881,970.

The present application also claims the benefit of U.S. provisional patent application Ser. No. 63/440,111, filed Jan. 20, 2023. The content of each of the above-referenced applications is hereby incorporated by reference in its entirety.

### FIELD

Embodiments of the present disclosure generally relate to an automatic door control system for controlling the motorized opening and closing of doors or shutters of a building.

### BACKGROUND

Automatic door control systems are used to control the motorized opening and closing of a door or shutter in accordance with one or more predetermined conditions, circumstances, or criteria. For example, the opening or closing of a door or shutter may correspond to the regulation of a temperature inside a building, such as a livestock building, which requires precise temperature regulation to ensure the wellbeing and productivity of the animals. Similarly, shutters or windows of greenhouses may also require similar control in order to ensure proper growing conditions.

Conventional automatic door control systems utilize a motorized unit that drives motion of the door or shutter between fully opened and fully closed positions. Before operation, the motorized unit must be calibrated to set the fully closed and fully opened positions, as well as any intermediary target positions that are between these extreme positions of the door or shutter.

The calibration of the motorized unit generally requires an operator to utilize controls that are mounted to the motorized unit. As a result, when the motorized unit is installed at an elevated location, the operation must climb a ladder or otherwise elevate themselves to perform the calibration, which may involve multiple operations and recalibrations to achieve the correct settings for the automatic door control system. Accordingly, the conventional calibration routine for automatic door control systems is cumbersome and presents a safety hazard to the operator.

### SUMMARY

Embodiments of the present disclosure relate to an automatic door control system that provides advantages over the conventional systems discussed above.

One embodiment of the door control system includes a door element that rotates in response to a change in position of a door, a first door position sensor configured to output a position signal based on rotation of the door element, a controller and a control device. The controller incudes memory containing a target position corresponding to an intermediate position of the door between maximally open and maximally closed positions of the door, and a processor configured to monitor a current position of the door based on the position signal and stop rotation of the door element when the current position matches the target position. The control device is configured to set the target position in the memory through a wireless communication link with the controller.

Another embodiment of the automatic door control system includes a door element that rotates in response to a change in position of a door, a first door position sensor configured to output a position signal based on rotation of the door element, an environmental sensor configured to sense an environmental parameter and output an environmental parameter signal that is indicative of the sensed environmental parameter and a controller. The controller includes memory containing a plurality of target positions each corresponding to a different position of the door including an intermediate position that is between maximally open and maximally closed positions of the door, and a processor. The processor is configured to select one of the plurality of target positions based on the environmental parameter signal, monitor a current position of the door based on the position signal and stop rotation of the door element when the detected position is indicative of the selected target position.

Additional embodiments relate to methods of controlling a position of a door using the system, and methods of calibrating the system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified top view of a building with multiple automatic door control systems, in accordance with embodiments of the present disclosure.

FIG. 2 is a simplified diagram of an example of an automatic door control system, in accordance with embodiments of the present disclosure.

FIGS. 3A-C are simplified front views of a door of an opening in various positions.

FIG. 4 is a simplified circuit diagram of an example controller, in accordance with embodiments of the present disclosure.

FIG. 5 is a flowchart illustrating an example operation of the automatic door control system in an automatic mode, in accordance with embodiments of the present disclosure.

FIG. 6 is a simplified diagram of example door position sensors, in accordance with embodiments of the present disclosure.

FIG. 7 is a simplified diagram of a door position sensor, in accordance with embodiments of the present disclosure.

FIG. 8 is a flowchart illustrating an example calibration routine, in accordance with embodiments of the present disclosure.

FIG. 9 is a flowchart illustrating an example operation of an automatic door control system when main power is interrupted, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

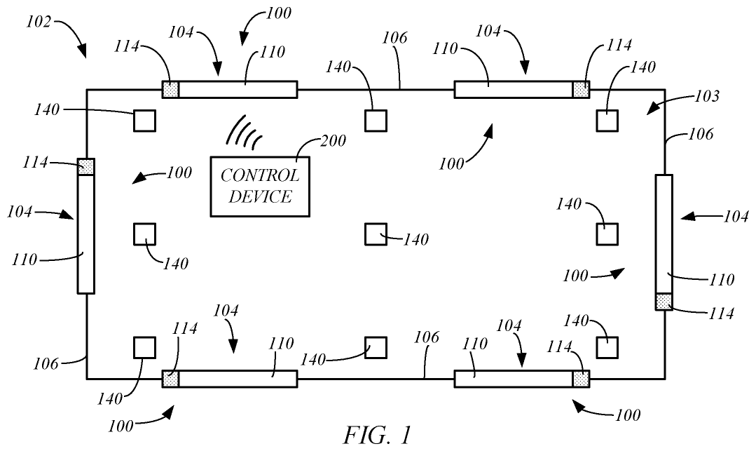

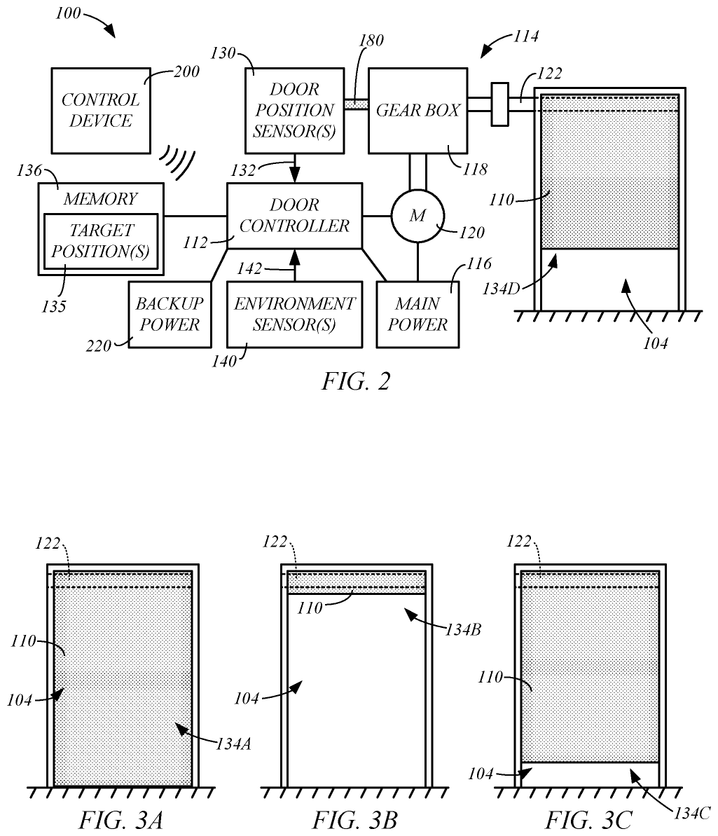

FIG. 1 is a simplified top view of multiple automatic door control systems 100 in use with a building 102, such as a livestock building, housing chickens, pigs or other livestock within an interior 103, or a greenhouse, in accordance with embodiments of the present disclosure. FIG. 2 is a simplified diagram of one of the automatic door control systems 100, in accordance with embodiments of the present disclosure.

The systems 100 are used in connection with corresponding openings 104 through exterior walls 106 of the building 102. Each automatic door control system 100 includes a conventional door 110 that may fully cover one of the openings 104 when in a fully closed position and exposes the interior of the building to the outside through the opening when in a fully opened position. As used herein, the term “door” 110 should be understood as including any type of door, screen, shutter, window, vent, damper, or other feature of a structure that may be opened or closed by an automatic motorized mechanism, such as the system 100.

The automatic door control system 100 includes a door controller 112 and a motorized unit 114, which is controlled by the door controller 112 to drive the opening and closing of the door 110. The door controller 112, the motorized unit 114 and other components of the system 100 may be powered by the main power 116, which may represent line power from an electrical power grid or utility, or another suitable power source.

The motorized unit 114 may take on any suitable form. In one example, the motorized unit 114 may comprise a transmission or gear box 118 and a motor 120. The gear box 118 operates to apply torque from the motor 120 to a main shaft 122 to open or close the door 110. The main shaft 122 may include an axle of a roller door 110, a shaft for driving a pulley wheel or gear that moves the door 110 (e.g., upward or downward, or horizontally), an axis about which the door 110 may be rotated, or another mechanism that operates to open or close the corresponding door 110. Typically, rotation of main shaft 122 in one direction about its axis causes the door 110 to open, while rotation of main shaft 122 in the opposite direction causes the door 110 to close.

The system 100 may include one or more door position sensors 130, each of which may generate a position signal 132 that is indicative of a position of the door 110, or that may be used by the controller 112 to determine or calculate the position of the door 110. Example door positions 134 are illustrated in FIG. 2 and FIGS. 3A-C, which are simplified front views of the door 110 operating in connection with an opening 104. The door position examples include a fully closed position 134A (FIG. 3A), a fully opened position 134B (FIG. 3B), and one or more intermediary positions 134C and 134D (FIGS. 2 and 3C) between the fully closed position 134A and the fully opened position 134B. Target position values 135 representing these or other positions 134 of the door 110 may be stored in memory 136 of the system 100, such as following a calibration routine.

In some embodiments, the door controller 112 operates to automate the positioning of the door 110 based on one or more signal inputs relating to a sensed or detected condition, such as a time of day, an environmental condition, and/or another condition. Such conditions may be used by the door controller 112 to determine when the door position 134 should be changed and to what degree it should be changed.

Environmental conditions or parameters may be sensed or detected using environmental sensors 140 (FIGS. 1 and 2), each of which output an environmental parameter signal 142 that is indicative of the sensed parameter or condition. Examples of environmental sensors 140 include temperature sensors, humidity sensors, light sensors, anemometers, precipitation sensors, air particulate sensors, and/or other environmental sensors. Thus, the environmental sensors 140 may produce signals 142 that are indicative of a sensed temperature inside the building 102 and/or outside the building 102, a relative humidity inside the building 102 or outside the building 102, a rate of insolation, a wind velocity (e.g., speed, direction, or both), a precipitation measurement, a concentration of a substance (e.g., concentration of a pollutant or other particulate or chemical substance in the air within the structure), and/or another environmental condition.

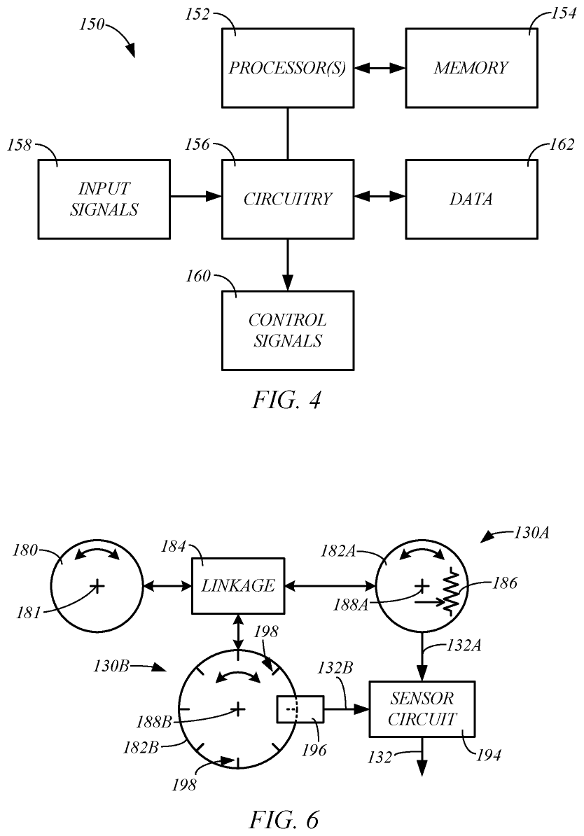

The door controller 112 may represent a single controller or multiple controllers and may perform various functions and process steps described herein. The door controller 112 may take the form of the example controller 150 shown in the simplified circuit diagram of FIG. 4. The controller 150 includes one or more processors 152 and has access to memory 154, which may be a component of the controller 150, as indicated in FIG. 4, or it may be a separate component of the system 100, such as memory 136 as indicated in FIG. 2. The one or more processors 152 are configured to perform various functions and process steps described herein in response to the execution of instructions contained in the memory 154.

The one or more processors 152 may be components of one or more computer-based systems, and may include one or more control circuits, microprocessor-based engine control systems, and/or one or more programmable hardware components, such as a field programmable gate array (FPGA). The memory 154 and the memory 136 (FIG. 2) represents local and/or remote memory or computer readable media. Such memory comprises any suitable patent subject matter eligible computer readable media and does not include transitory waves or signals. Examples of the memory include conventional data storage devices, such as hard disks, CD-ROMs, optical storage devices, magnetic storage devices, flash, and/or other suitable data storage devices. The controller 150 may include circuitry 156 for use by the one or more processors 152 to receive input signals 158 (e.g., sensor signals), issue control signals 160 (e.g., signals for controlling the motorized unit, etc.) and/or communicate data 162, such as in response to the execution of the instructions stored in the memory 154 and/or 136 by the one or more processors 152.

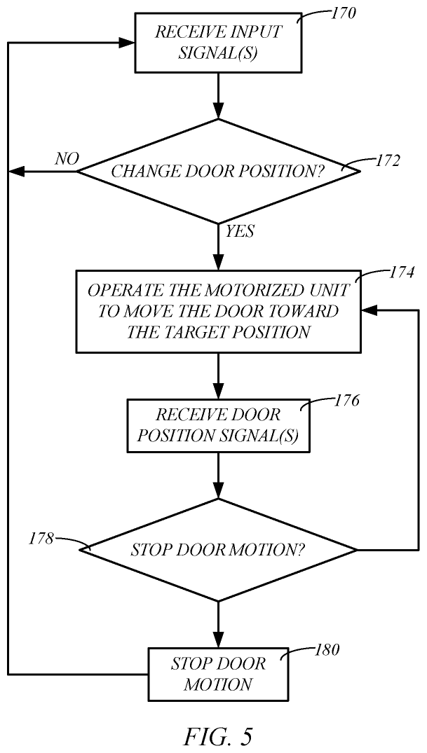

FIG. 5 is a flowchart illustrating an example operation of the system 100 in an automatic mode, in accordance with embodiments of the present disclosure. At 170, the door controller 112 receives one or more input signals 158 from one or more sensors, such as a time signal from a clock, one or more environmental parameter signals 142 indicating an environmental condition from one or more of the environmental sensors 140, or another sensor signal. The input signals 158 may also include a position signal 132 from at least one door position sensor 130 that is used by the door controller 112 to determine the current position of the door 110.

At 172 the received input signals 158 may be analyzed by the door controller 112 (e.g., processor(s) 152 and/or circuitry 156) in accordance with one or more criteria to determine whether the position 134 of the door 110 should be changed from its current position indicated by the one or more door position signals 132. This generally involves determining a corresponding target position 135 for the door based on analyzed input signals 158, such as the time, the interior and/or exterior temperature, the interior and/or exterior humidity, and/or other conditions, such as those described above. This determination may involve comparing a value that is indicated by a received sensor signal or is calculated based on one or more of the received sensor signals (e.g., calculated on the basis of a predetermined formula or algorithm), to one or more predetermined thresholds, ranges of values, or other criteria to determine the corresponding target position 135 of the door 110. Thus, the controller 112 uses a value representing a sensed or detected condition indicated by one or more of the input signals 158 (e.g., sensor signals 142) to obtain a corresponding target door position 135.

If the door controller 112 determines that the door position 134 should not be changed, the method returns to 170 where the door controller 112 continues to receive and analyzes input signals 158.

If the controller 112 determines that the target position 135 is different from the current position of the door 110, such as by a threshold amount, the controller 112 operates the motorized unit 114 to move the door 110 toward the target position 135, as indicated at 174. Feedback on the current position of the door 110 may be provided by the door position signals 132 of one or more door position sensors 130, at 176. The door controller 112 may periodically compare the current position of the door indicated by the position signal(s) 132 to the target position 135 at 178 to determine whether movement of the door should be stopped, and stop the movement of the door 110 by the motorized unit 114 when the current position matches the target position 135 at 180. Otherwise, the method returns to 174. For example, at step 178, the door controller 112 may send a signal to the motorized unit 114 to stop the motor 120, interrupt electrical power to the motor 120, trigger a clutch mechanism of the gear box 118 to disengage the motor 120 from the main transmission shaft 122, or otherwise cause rotation of the main transmission shaft 122 to stop.

Examples of the door position sensors 130 will be described with reference to the simplified diagram of FIG. 6. In some embodiments, the system 100 includes a door element 180 that rotates about an axis 181 in response to a change in the position of the door 110. As mentioned above, the system 100 may include a main shaft 122 that is rotated by the motor 120, such as through a gear box or transmission 118 (FIG. 2), to drive a change in the position of the door 110. Examples of the door element 180 include the main shaft 122 or a separate component (e.g., shaft, gear, etc.) that is connected to the main shaft 122 through a suitable linkage (gear chain, pulley, belt, etc.) such that rotation of the main shaft 122 drives rotation of the door element 180 about the axis 181.

The one or more door position sensors 130 may include a door position sensor 130A and/or a door position sensor 130B. In one embodiment, each door position sensor 130 operates to output a position signal 132 that is indicative of the position of the door 110 based on rotation of the door element 180. Each door position sensor may include a corresponding sensor element 182A and 182B that is mechanically linked to the door element 180 through a suitable linkage 184 that drives rotation of the sensor elements 182 in response to or with rotation of the door element 180. Alternatively, the door position sensors 130 may share the same sensor element 182. Examples of the linkage 184 include a gear train, a belt, or another suitable linkage.

One embodiment of door position sensor 182A includes a potentiometer 186 having a resistance that changes with rotation of the sensor element 182A about its axis 188A. That is, rotation of the sensor element 182A in one direction may increase resistance of the potentiometer 186, while rotation in the opposite direction may decrease the resistance of the potentiometer 186. Thus, the potentiometer 186 has a different resistance for different positions of the door 110. This may be accomplished using various conventional techniques. For example, the sensor element 182A may be coupled to a wiper or sliding contact of the potentiometer 186 such that a given total angle of rotation (e.g., that may have a value in excess of a full rotation of 360°, due to multiple rotations) of the sensor element 182A is unambiguously indicative of the position of the door 110.

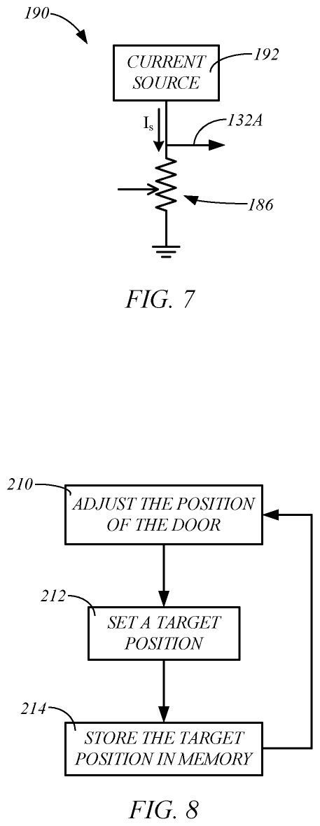

The door position sensor 130A may output a position signal 132A that is based on the resistance of the potentiometer 186 and indicates the position of the door 110. FIG. 7 is a simplified circuit diagram illustrating an option for generating the position signal 132A. In the example circuit 190, a current source 192 supplies a sense current Is that is delivered through the variable resistance of the potentiometer 186. The position signal 132A may comprise the voltage across the variable resistance of the potentiometer 186, as indicated in FIG. 6. A sensor circuit 194 may be used to process the position signal 132A (e.g., amplify, digitally sample, etc.) before delivering it to the door controller 112 (FIG. 2).

The door controller 112 may use the position signal 132A (step 170) to determine a current position of the door 110 (step 172) using any suitable technique. In one example, a mapping of the position signal 132A or a value represented by the position signal 132A indicating the resistance of the potentiometer 186 to a position of the door 110 may be stored in the memory 136, 154. Thus, the door controller 112 may obtain the position of the door 110 based on the position signal 132A using the mapping. The stored mapping may comprise an index of the measured resistance indicated by the position signal 132A to the door position, an equation correlating the door position to the measured resistance, or another suitable mapping. Thus, the door controller 112 may use the position signal 132A to determine if the current position of the door 110 is different from a target position 135 of the door 110 (step 172), and whether door 110 should be moved using the motorized unit 114 in step 174 of the method.

One embodiment of the door position sensor 130B comprises an encoder that is configured to detect rotation of the door element 180. In one example, the encoder includes the sensor element 182B, such as an encoder wheel, that rotates about an axis 188B with or in response to rotation of the door element 180, such as through the linkage 184 as discussed above. The encoder 130B includes a rotation sensor 196 that detects the rotation of the sensor element 182B and, thus, the rotation of the door element 180. In some embodiments, the position signal 132B includes pulses, wherein each pair of pulses indicates a predefined angular rotation of the sensor element 182B and a corresponding change in position of the door 110. The door controller 112 may maintain a count of the pulses either in a positive direction or negative direction depending on the direction of rotation of the sensor element 182B to maintain an aggregate angular displacement of the sensor element 182B and the door element 180. A correlation of this measured angular displacement to the position of the door 110 may be maintained in the memory 136, 154. As with the position sensor 130A, a mapping may be used to correlate the measured angular displacement to the position of the door 110, and may comprise an index between the measured angular displacement and the position of the door 110, an equation that correlates the measured angular displacement to the position of the door 110, or another suitable mapping.

The rotation sensor 196 may take on any suitable form. For example, the rotation sensor 196 may comprise a conventional optical sensor that is configured to detect indicia 198 on the sensor element 182B, such as markings, slots, etc. that are angularly spaced around the sensor element 182B, as shown in FIG. 6, in accordance with conventional encoders. In another example, the sensor element or encoder 182B includes one or more magnets and the rotation sensor includes a conventional Hall Effect sensor that detects the magnetic field of the magnets as they are rotated past the rotation sensor 196 to detect the rotation of the sensor element 182B.

Additional embodiments relate to a method of calibrating the system 100 to designate one or more target positions 135 for the door 110. The target positions 135 may be associated with one or more conditions, such that when a condition is detected, the door controller 112 automatically moves the door 110 to the corresponding target position 135.

In one embodiment, the system 100 includes both the position sensor 130A and the position sensor 130B. Thus, the position of the door 110 may be derived from either the position signal 132A or the position signal 132B. The controller 112 may compare the positions of the door determined through the signals 132A and 132B as a check to determine whether the system 100 is operating properly. A mismatch between the positions determined using the signals 132A and 132B may indicate a malfunction. In the event of a main power failure and/or a loss of the current door position in the memory 136, 154, the door controller 112 may use the position indicated by the resistance of the potentiometer 186 presented in the signal 132A to reset the position determined using the encoder position signal 132B. Thus, in some embodiments, the door controller 112 may use the position signal 132A to determine a starting position of the door 110 and use the position signal 132B from the encoder 130B to measure subsequent changes in the door position.

As mentioned above, automatic door system calibration routines generally require an operator to utilize controls that are mounted to the motorized unit. Such routines can be cumbersome and may present a hazard to the operator due to the need to operate the motorized unit while standing on a ladder, for example. Additionally, these calibration routines may require more than one person.

In some embodiments, the system 100 includes a control device 200 that allows an operator to perform a calibration routine of the system 100 without having to operate door position controls at the motorized unit 114, thereby simplifying the calibration routine and improving the safety of the operator.

The control device 200 may take the form of a dedicated remote device for the system 100, a smartphone, a computing device (e.g., stationary or portable computer) or another suitable control device. The control device 200 may be authenticated or authorized to interact with the system 100 or door controller 112 by a unique application or identification code (e.g., a service set identifier, or SSID) that is programmed into the control device.

The control device 200 may generally comprise electronics in the form of the controller 150 shown in FIG. 4. Thus, the control device 200 includes one or more processors 152, memory 154 and/or circuitry 156, as indicated in FIG. 4. The functions performed by the control device 200 may be in response to the execution of instructions contained in its memory 154 by the one or more processors 152. The circuitry 156 of the control device 200 may include a suitable interface (e.g., touch screen, keyboard, etc.) for receiving input signals 158, and communications circuitry for communicating control signals 160, such as control signals to the door controller 112 during the calibration routine through a wireless communication link (e.g., WiFi, Bluetooth, etc.) or a wired communication link (e.g., Ethernet, RJ45, etc.).

FIG. 8 is a flowchart illustrating a calibration routine that is performed using the control device 200, in accordance with embodiments of the present disclosure. The calibration routine may be performed upon initially setting up the automatic door control system 100. The calibration routine may include a graphical user interface, such as on a smartphone form of the device 200, that leads the operator through predefined calibration steps to set specific target positions 135, such as the fully closed position 134A, the fully opened position 134B, or an intermediate position 134C or 134D, for example.

At 210 of the method, the operator adjusts the position of the door 110 to a desired target position using the control device 200 by communicating control signals 160 to the door controller 112. When the door 110 is in the desired position, the control device 200 may set a target position 135 by issuing a corresponding control signal 160 to the door controller 112, as indicated at 212. The door controller 112 may then measure the door position using the position signal(s) 132 from the door position sensor(s) 130 and store the measured door position in the memory 136, 154 as a target position 135, at 214.

The user may also associate one or more conditions (e.g., time, environmental condition, etc.) with the target position 135 in step 212, such that when the condition is met, the door controller 112 moves the door 110 to the target position 135 (steps 172 and 174). For example, the user may associate a target position 135 with an interior temperature of the building 102 and program the door controller 112 to open the door 110 to the target position 135 when a temperature sensor 140 in the interior 103 of the building 102 detects a temperature that exceeds the temperature associated with the target position 135.

Steps 210 to 214 of the calibration routine may be repeated until all of the desired target positions 135 are set, such as the fully closed position or stop 134A, the fully opened position or stop 134B, and/or one or more intermediary positions (e.g., positions 134C and 134D).

In some embodiments, the memory 136, 154 may comprise non-volatile memory that is capable of maintaining the current measured angular displacement or position of the door 110 in the event of a failure of the main power 116. In one embodiment, the system 100 may be locked upon a failure of the main power 116 until cleared by an operator.

In some embodiments, the system 100 includes a backup power source 220 (FIG. 2), such as a battery, a charged capacitor, a power generator, or another suitable backup power source, that powers the door controller 112 and the encoder 130B to allow the current position to be maintained in the memory 135, 154, when the main power 116 fails. While the method may be described in connection with the encoder 130B, it is understood that the method may be used with a different type of door position sensor 130 that must be powered to maintain a current position of the door 110 in the memory 136, 154.

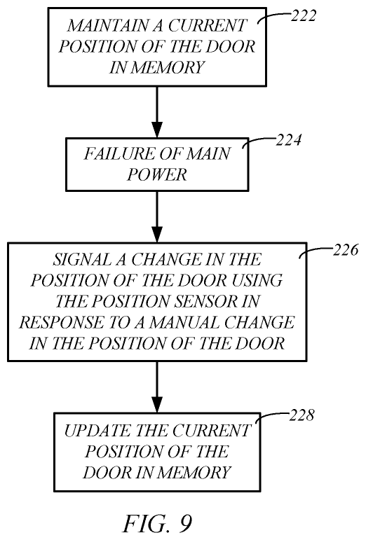

FIG. 9 is a flowchart illustrating an example operation of an automatic door control system 100 when the main power 116 fails (e.g., interrupted), in accordance with embodiments of the present disclosure. The method generally operates to maintain and update the current position of the door 110 in the memory 136, 154 in the event of a failure of the main power 116. At 222 of the method, a current position of the door 110 is maintained or updated in the memory 136, 154 by the door controller 112 based on position signals 132B received from the rotation sensor 196 of the encoder 130B in response to changes in the position of the door 110, while the door controller 112 and the encoder 130B are powered by the main power 116. At 224, a failure of the main power 116 occurs, and power is maintained or restored to the door controller 112 and the encoder 130B using the backup power source 220. The detection of failure of the main power 116 and the triggering of the use of the backup power source 220 may be provided using conventional power backup circuitry, which may be represented by the door controller 112. The backup power source 220 may be configured to only power the components of the door controller 112 and the encoder 130B that are required to maintain the current position of the door 110.

At 226 of the method, the rotational sensor 196 produces position signal(s) 132B in response to the rotation of the sensor element 182B in response to a change in the position of the door 110, while being powered by the backup power source 220. The change in the position of the door 110 may occur through a manual operation of the door (e.g., by hand, using a hand crank, using a drill, etc.). At 228, the door controller 112 updates the current position of the door 110 in the memory 136, 154 based on the position signal(s) 132B, while the door controller 112 or portions thereof are powered by the backup power source 220. When the main power 116 is restored, the backup power source 220 may be disconnected and the door controller 112 and the encoder 130B may be powered by the main power source 116, and return to normal operation.

Although the embodiments of the present disclosure have been described with reference to preferred embodiments, workers skilled in the art will recognize that changes may be made in form and detail without departing from the spirit and scope of the present disclosure.

Specific details are given in the above-description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or may be shown in block diagram form in order to not obscure the embodiments in unnecessary detail.

As used herein, when one or more functions or process steps are described as being performed by a controller (e.g., a specific controller), one or more controllers, at least one controller, a processor (e.g., such as a specific processor), one or more processors or at least one processor, embodiments include the performance of the function(s) by a single controller or processor, or multiple controllers or processors, unless otherwise specified. Furthermore, as used herein, when multiple functions are performed by at least one controller or processor, all of the functions may be performed by a single controller or processor, or some functions may be performed by one controller or one processor, and other functions may be performed by another controller or processor. Thus, the performance of one or more functions by at least one controller or processor does not require that all of the functions are performed by each of the controllers or processors.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected,” “coupled,” or “attached” to another element, it can be directly connected, coupled or attached to the other element, or it can be indirectly connected, coupled, or attached to the other element where intervening or intermediate elements may be present. In contrast, if an element is referred to as being “directly connected,” “directly coupled” or “directly attached” to another element, there are no intervening elements present. Drawings illustrating direct connections, couplings or attachments between elements also include embodiments, in which the elements are indirectly connected, coupled or attached to each other.

As will be appreciated by one of skill in the art, embodiments of the present disclosure may be embodied as methods, systems, devices, and/or computer program products. Accordingly, embodiments of the present disclosure may take the form of an entirely hardware embodiment, an entirely software embodiment or an embodiment combining software and hardware aspects. The computer program or software aspect of embodiments of the present disclosure may comprise computer readable instructions or code stored in a computer readable medium or memory. Execution of the program instructions by one or more processors (e.g., central processing unit) results in the one or more processors performing one or more functions or method steps described herein. Any suitable patent subject matter eligible computer readable media or memory may be utilized including, for example, hard disks, CD-ROMs, optical storage devices, or magnetic storage devices. Such computer readable media or memory do not include transitory waves or signals.

Embodiments of the present disclosure may also be described using flowchart illustrations and block diagrams. Although a flowchart or block diagram may describe the operations as a sequential process, many of the operations can be performed in parallel or concurrently. In addition, the order of the operations may be re-arranged. In addition, the order of the operations may be re-arranged. Embodiments of methods described herein include not preforming method steps and embodiments described herein. A process is terminated when its operations are completed, but could have additional steps not included in a figure or described herein.

Unless otherwise specified, the term “about” or “substantially” refers to ±10% and the symbol denotes equality with a tolerance of at most 10%, unless stated otherwise.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween as individual, separate embodiments.

It is appreciated that separately described embodiments of the present disclosure may also be combined with one or more other disclosed embodiments into a single embodiment. Conversely, various features of embodiments of the disclosure that are described in the context of a single embodiment, may also be considered as separate embodiments.

Certain features described in the context of various embodiments are not to be considered as essential features of those embodiments unless the embodiment is inoperative without those features.

What is claimed is:

1. An automatic door control system comprising:
a door element that rotates in response to a change in position of a door;
a first door position sensor configured to output a position signal based on rotation of the door element;
a controller comprising:
memory containing a target position corresponding to an intermediate position of the door between maximally open and maximally closed positions of the door; and
a processor configured to monitor a current position of the door based on the position signal and stop rotation of the door element when the current position matches the target position; and
a control device configured to set the target position in the memory through a wireless communication link with the controller.

2. The system according to claim 1, wherein:
the first door position sensor comprises:
a first sensor element that rotates in response to rotation of the door element; and
a potentiometer having a resistance that increases with rotation of the first sensor element in a first direction and decreases with rotation in a second direction that is opposite the first direction; and
the position signal corresponds to the resistance of the potentiometer.

3. The system according to claim 2, wherein the target position contained in the memory corresponds to a target resistance of the potentiometer.

4. The system according to claim 1, wherein:
the first door position sensor comprises an encoder configured to detect rotation of the door element; and
the position signal corresponds to the detected rotation.

5. The system according to claim 4, wherein the encoder comprises:
a first sensor element that rotates in response to rotation of the door element; and
a rotation sensor configured to detect rotation of the first sensor element.

6. The system according to claim 4, wherein:
the controller is configured to maintain and update the current position of the door in the memory based on the position signal;
the system includes a main power source that powers the first door position sensor and controller during normal operation;
the system includes a backup power source that powers the controller and the first door position sensor when the main power source fails; and
when the main power source fails:
the first position sensor produces one or more position signals indicating a change in the position of the door using power from the backup power source; and
the controller updates the current position of the door in the memory based on the one or more position signals using power from the backup power source.

7. The system according to claim 4, wherein:
the system includes a second door position sensor comprising a potentiometer having a resistance that varies in response to rotation of the door element; and
the controller is configured to detect a current position of the door based on the resistance.

8. The system according to claim 7, wherein the controller is configured to stop rotation of the door element when the resistance is indicative of the target position.

9. The system according to claim 1, wherein:
the system includes an environmental sensor configured to sense an environmental parameter and output an environmental parameter signal that is indicative of the sensed environmental parameter;
the memory includes a plurality of target positions, each corresponding to a different position of the door; and
the processor is configured to select one of the plurality of target positions based on the sensed environmental parameter and stop rotation of the door element when the detected position is indicative of the selected target position.

10. The system according to claim 9, wherein the memory includes a mapping of each of the plurality of target positions to a different value of the environmental parameter.

11. The system according to claim 10, wherein the environmental sensor is selected from the group consisting of a temperature sensor and a humidity sensor.

12. An automatic door control system comprising:
a door element that rotates in response to a change in position of a door;
a first door position sensor configured to output a position signal based on rotation of the door element;
an environmental sensor configured to sense an environmental parameter and output an environmental parameter signal that is indicative of the sensed environmental parameter; and
a controller comprising:
memory containing a plurality of target positions each corresponding to a different position of the door including an intermediate position that is between maximally open and maximally closed positions of the door; and
a processor configured to:
select one of the plurality of target positions based on the environmental parameter signal;
monitor a current position of the door based on the position signal; and
stop rotation of the door element when the detected position is indicative of the selected target position.

13. The system according to claim 12, further comprising a control device configured to set the target position corresponding to the intermediate position in the memory through a wireless communication link with the controller.

14. The system according to claim 12, wherein:
the first door position sensor comprises:
a first sensor element that rotates in response to rotation of the door element; and
a potentiometer having a resistance that increases with rotation of the first sensor element in a first direction and decreases with rotation in a second direction that is opposite the first direction; and
the position signal corresponds to the resistance of the potentiometer.

15. The system according to claim 12, wherein:
the first door position sensor comprises an encoder configured to detect rotation of the door element; and
the position signal corresponds to the detected rotation.

16. The system according to claim 15, wherein the encoder comprises:
a first rotational element that rotates in response to rotation of the door element; and
a rotation sensor configured to detect rotation of the first rotational element.

17. The system according to claim 15, wherein:
the system includes a second door position sensor comprising a potentiometer having a resistance that varies in response to rotation of the door element; and
the controller is configured to detect a current position of the door based on the resistance.

18. The system according to claim 12, wherein:
the controller is configured to maintain and update the current position of the door in the memory based on the position signal;
the system includes a main power source that powers the first door position sensor and controller during normal operation;
the system includes a backup power source that powers the controller and the first door position sensor when the main power source fails; and
when the main power source fails:
the first position sensor produces one or more position signals indicating a change in the position of the door using power from the backup power source; and
the controller updates the current position of the door in the memory based on the one or more position signals using power from the backup power source.

19. The system according to claim 12, wherein the memory includes a mapping of each of the plurality of target positions to a different value of the environmental parameter.

20. The system according to claim 19, wherein the environmental sensor is selected from the group consisting of a temperature sensor and a humidity sensor.
